(19) United States
(12) Patent Application Publication
(10) Pub. No.: US 2016/0355049 A1
(43) Pub. Date: Dec. 8, 2016

(54) Portable, Foldable Dry-Erase Board

(71) Applicant: Robert George Fahnestock Thomas, Chevy Chase, MD (US)

(72) Inventor: Robert George Fahnestock Thomas, Chevy Chase, MD (US)

(21) Appl. No.: 13/844,743

(22) Filed: Mar. 15, 2013

(51) Int. Cl. B43L 1/00

(52) U.S. Cl. CPC B43L 1/00

(57) ABSTRACT

A portable, foldable dry-erase board comprised of multiple sheets of relatively thin and relatively rigid material arranged in a regular manner constituting the body of said dry-erase board, where the sheets are covered with a thin, flexible plastic laminate suitable for use with standard dry-erase markers, with said plastic serving as both a writing surface and as a matrix securing said sheets, and where the board can be folded into a compact form along the laminated seams between said sheets.

### TECHNICAL FIELD

The invention relates to the field of portable dry-erase writing boards.

### BACKGROUND OF THE INVENTION

Dry-erase boards, also known as whiteboards, dry-wipe boards, and greaseboards, are a well-known technology. Such boards are used in a variety of instructional, office, and even home environments, where they serve as a medium for conveying written information in a relatively stable fashion that can nevertheless be erased with little effort or mess. Because of their ease of use and the clarity with which they display written information, dry-erase boards have come to replace traditional chalkboards in many settings.

The general manner in which dry-erase boards function is well known. U.S. Pat. No. 3,949,132 describes an early dry-erase board and ink system comprised of a non-porous plastic board that can be eraseably written on using an ink that combines a dye with a volatile release agent. When the ink is applied to the non-porous plastic board the release agent evaporates and a thin film of insoluble pigment is deposited. Because the film is not chemically bound to or diffused within the non-porous board, it can be wiped off with relative ease.

For all their advantages, standard dry-erase boards tend to be heavy, relatively expensive, and they are typically fixed in specific locations, such as classrooms or conference rooms. While this is not a difficulty for the typical use of such boards, the inventor of the present invention has found there is a long-felt and unmet need for a type of dry-erase board that is lightweight, inexpensive, foldable, and reusable.

Rolls of plastic dry-erase material are also known in the prior art. Paper-like materials in rolls are too flexible for many applications and are bent and creased easily, which detracts from their usability. They lack the desirable balance the present invention strikes between rigidity, compactness, ease of use, and portability.

Small-scale whiteboards also exist, but, like traditional whiteboards, they are still often too large and bulky to be transported easily and are relatively expensive to manufacture. The present is inexpensive to manufacture, relatively rigid, and portable, rendering it conducive to the process of rapid ideation and prototyping in a wide variety of environments.

### SUMMARY OF THE INVENTION

The present invention combines many of the features that have made standard dry-erase boards so successful with the ease of use and portability more commonly associated with a pad of paper or small notebook. It is an improvement over the portability and versatility of standard dry-erase boards, which are typically made of thick wood composite materials, rendering them costly to manufacture and unwieldy to transport and store.

The body of the portable, foldable dry-erase board of the present invention is comprised of an array of individual sheets separated from one another by a small gaps. The sheets, made of cardstock or other relatively sturdy material, may be attached to one another by tabs or other means, such as tape or adhesive strips, and are coated on both sides by a plastic laminate, which provides a impermeable surface suitable for the application and removal of dry erase ink. The gaps in between the sheets form seams when laminated. The assembly can be folded along these seams and compacted, like a travel map, to roughly the size of one of its component sheets. The laminate further ensures the assembly is water resistant.

### BRIEF DESCRIPTION OF THE DRAWINGS

A more complete and thorough understanding of the present embodiments and advantages thereof may be acquired by referring to the following description taken in conjunction with the accompanying drawings, wherein:

FIG. 1 is a top view from a side perspective of a rectangular array of sheets according to the present invention;

FIG. 2 is a top view of a rectangular array of sheets according to the present invention, with the selected portion displayed in FIG. 3;

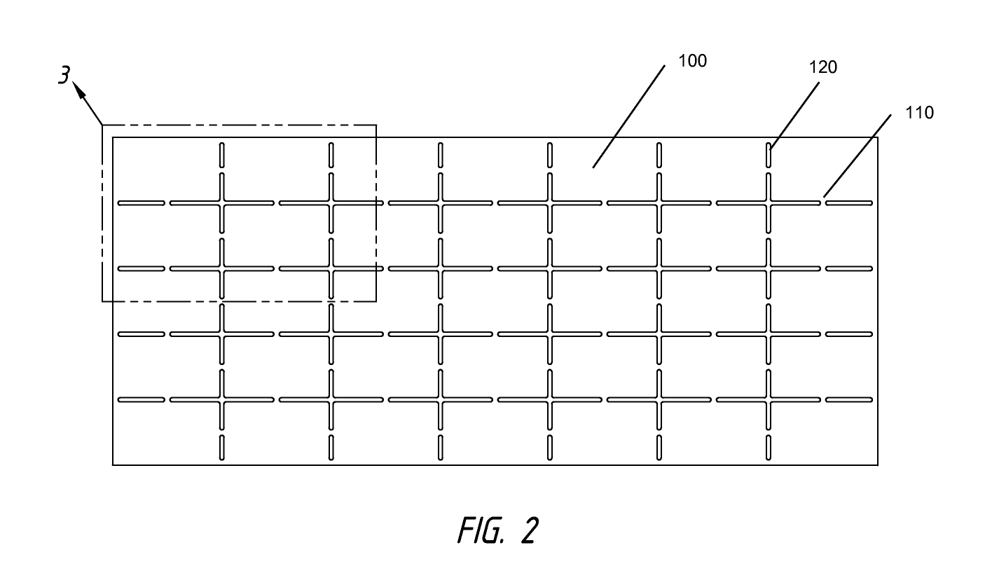

FIG. 3 is a close-up top view of a section of an array of sheets according to the present invention on which four overlapping grids have been preprinted using different types of lines;

FIG. 4 is a side perspective view depicting an array of sheets according to the present invention in folded form.

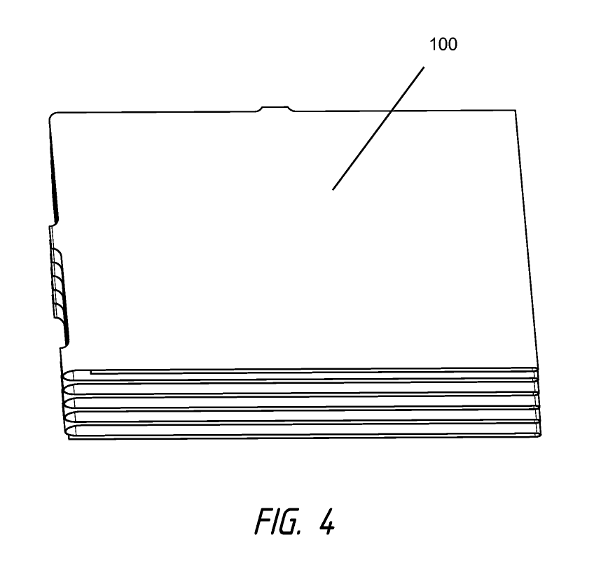

### DETAILED DESCRIPTION OF THE INVENTION

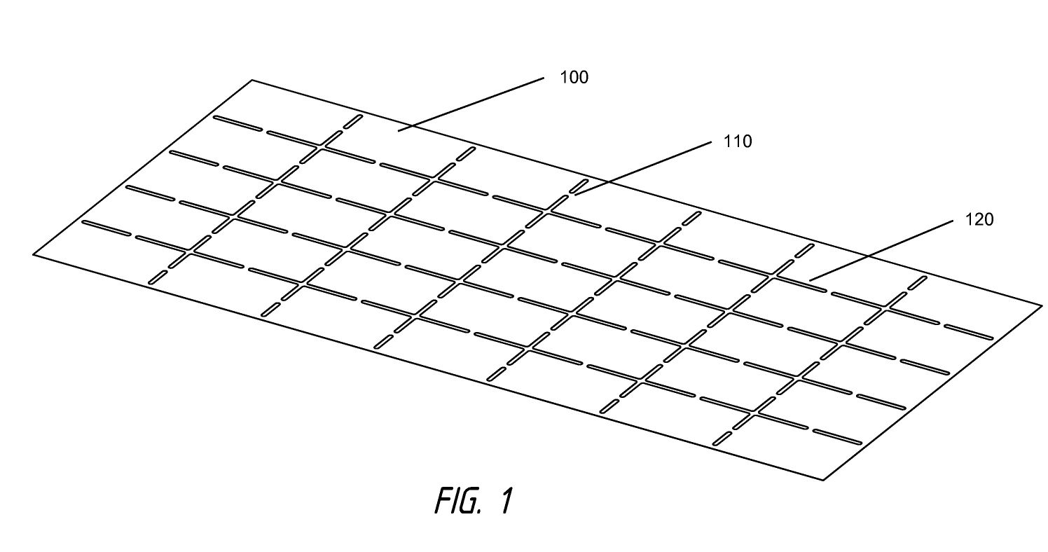

One embodiment of the present invention, illustrated in FIG. 1, involves forming a clear, non-porous polyester plastic laminate over a 5×7 array of 3×5 inch rectangular cards made of relatively rigid (e.g., 100 lb) white cardstock. The individual cards or sheets 100 may be fully detached or partly connected to one another via tabs 110 or other means. Having a physical link between the sheets imparts additional rigidity to the assembly and offers greater stability during the lamination process. Once laminated, the array of sheets provides a lightweight and relatively inexpensive medium on which markings from standard dry-erase markers can be made and erased. So long as the gap between the sheets 120 is small in relation to their overall size (e.g., ⅛ inch gap between 3×5 inch sheets), the plastic laminate seams will not unduly compromise the structural integrity of the array. The type and thickness of laminate used, the material from which sheets are made, the narrowness of the gap between sheets, and the nature of the connection between sheets will all influence the physical properties of the assembly, including its weight, rigidity, and ease of folding. Users can customize the product by cutting it along the seams to make a smaller dry-erase board or individual laminated note cards.

One skilled in manufacturing or lamination could readily create arrays from different components for different uses, just as the size, shape, and number of sheets can be modified to suit particular needs. As the range of acceptable variation is wide, such modifications would involve optimization for particular purposes would generally not hamper the utility of the invention. For example, sheets forming the assembly could be in the form of 1×1 inch squares or equilateral triangles with 3 inch sides.

The desired size, shape, and number of sheets comprising a given foldable dry-erase board and the type and thickness of laminate used will be dictated, among other things, by the size and weight of the sheets and how easily they can be folded. In a sense, the present invention is analogous to an equation, where modification of one variable (e.g., the type and thickness of laminate used, the material from which sheets are made, the narrowness of the gap between sheets, the nature of the connection between sheets, etc.) influences the potential range of other variables with regard to a given purpose. For example, in a portable, foldable dry-erase board intended for use by small children for drawing, it would be desirable to use smaller sheets made from relatively light material (e.g., 35 lb cardstock), which would require use of a particularly thin and flexible type of lamination.

While cardstock is a common, versatile, and inexpensive material that can be easily cut into sheets and laminated, and is therefore well-adapted for most implementations of the present invention, for some applications sheets with greater rigidity, such as woven carbon fiber or rigid plastics, may be desirable. Also, while a variety of non-porous plastic laminates may be used, such as polypropylyne, coated polyester, or fluorinated films, so long as they accept dry-erase markings in an erasable manner and are adapted for use in lamination processes, the laminate cannot be so thick or rigid that it prevents folding of the sheets.

The currently preferred embodiment of the present invention is intended for a variety of general uses and is made using white 100 lb 10pt C2S cover cardstock and clear 1.5 mil polyester laminate. As depicted in FIG. 1, the assembly is comprised of a 5×7 array of 3×5 inch rectangular cards or sheets 100 connected to their neighbors by small central tabs 110. The tabs are an intended result of an original large cardstock sheet not being fully cut into smaller sheets. The result is a relatively large (approximately 15×35 inches) portable, foldable dry-erase board that is inexpensive to manufacture and easy to fold but that is nonetheless relatively rigid and manipulable when open. The clear laminate over white cardstock provides strong contrast when written on with standard dry erase markers, rendering tracings easy to read. While this is the currently preferred embodiment, sheets of any color, or even black (to contrast with white, neon, and luminescent ink), could be used with the present invention. Additionally, the laminate itself need not be transparent and could come in a variety of opaque colors or transparent hues.

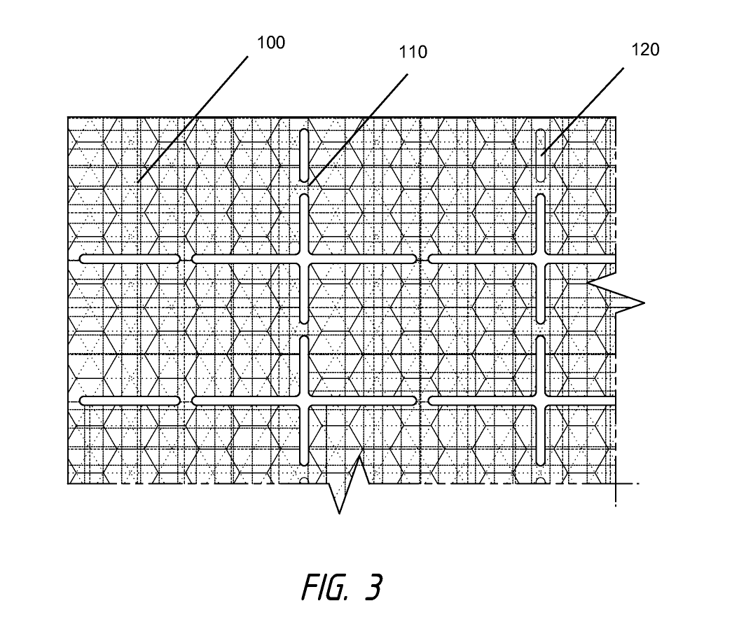

A further advantage of the present invention over other dry-ease boards is that it can be readily adapted to include preprinted material over which dry-erase markings can be made. For example, in the currently preferred embodiment one side is preprinted with four separate grids, each rendered in a different color and with a different type of line. FIG. 3. The grids can be used for a variety of purposes, including mapping, structuring drawings, creating a calendar or chore list, keeping statistics for sports, as a template for role-playing or other games, etc. Other printed material, such as logos, designs, or maps can also be preprinted on one or both sides of the portable, foldable dry-erase board of the present invention. Further, because each side is essentially a separate dry-erase board, printing material on one side does not interfere with the other side remaining blank for maximum versatility. Because the individual sheets are separate from one another, the present invention is particularly well-adapted to creating storyboards, comics, or other works where individuals panels are parts of an overall composition.

It should be noted that as a result of its overall design and construction the portable, foldable dry-erase board of the present invention has a variety of uses beyond simply retaining erasable tracings made with standard dry-erase ink. The laminate that renders the product suitable for use with dry-erase markers also makes it waterproof and durable, and the overall design makes it lightweight and easy to pack and carry. Thus, the invention not only serves as a convenient dry-erase board, it could also function as a portable rain protector, a placemat, a screen to mask items (as in a blind taste test or experiment), a projection surface, a backdrop for displays, a bug-swatter, etc. Basically, the inherent characteristics of the invention render it suitable for a variety of uses limited only by the imagination of the user.

Modifications and substitution by one of ordinary skill in the art are considered to be within the scope of the present invention, which is not limited except by the following claims.

What is claimed is:

1. An article of manufacture comprising:
an array of multiple sheets of material, such as paper cardstock, woven fiber, or plastic;
where each such sheet is joined to its neighboring sheets by one or more tabs or connecting elements; and
where the array of sheets is laminated with a material suitable for use with standard dry-erase markers;
such that the array of sheets is foldable along the laminate seams formed between said sheets.

2. The article of claim 1, wherein the sheets are relatively thin and relatively rigid.

3. The article of claim 1, wherein the sheets are each less than ⅛ inch thick and each less than 100 square inches in area.

4. The article of claim 1, wherein
the sheets are all cut from a single larger sheet and the connecting tabs between sheets are formed by only partially cutting out the smaller sheets.

5. The article of claim 1, wherein
each sheet is joined to its neighboring sheets by a single central tab or connecting element.

6. The article of claim 2, wherein
the sheets are made of paper cardstock.

7. The article of claim 6, wherein
the laminate is a clear and plastic.

8. The article of claim 7, wherein
one or both sides of the array of sheets is printed with a logo, design, drawing, grid, or other matter.

9. The article of claim 6, wherein
the laminate is further coated with a commercial dry-erase coating to facilitate the deposition and remove of dry-erase ink.

10. A portable, foldable dry-erase board comprised of:
multiple sheets of relatively thin and relatively rigid material, such as paper cardstock, woven fiber, or plastic, arranged in a regular manner and constituting the body of said dry-erase board;
wherein said sheets are covered with a thin, flexible laminate, such as polyethylene or polypropylene, suitable for use with standard dry-erase markers;
such that the laminate serves as both a writing surface and as a matrix securing said sheets; and
where the dry-erase board can be folded into a compact form along the laminated seams between said sheets.

11. The portable, foldable dry-erase board of claim 10, wherein the sheets of said relatively thin and relatively rigid material are rectangular and each sheet has an area less than 100 square inches.

12. The portable, foldable dry-erase board of claim 11, wherein one or both sides of said dry-erase board are printed with a logo, design, drawing, grid, or other matter.
